(19) United States
(12) Patent Application Publication
(10) Pub. No.: US 2006/0029487 A1
(43) Pub. Date: Feb. 9, 2006

(54) Method for binding a sheet stack into a binder, and binding apparatus for carrying out that method

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/195,863

(22) Filed: Aug. 3, 2005

(30) Foreign Application Priority Data
Aug. 3, 2004 (DE) 102004037806.1-26
May 13, 2005 (DE) 20 2005 007 860.3

(51) Int. Cl. B42C 9/00

(52) U.S. Cl. 412/34; 412/8

(57) ABSTRACT

A binding apparatus and method binds a sheet stack into a binder having a binder spine and an adhesive strip present on the spine's inner side. The binding apparatus comprises an input slot that is delimited by a plate and has an input opening and pressing device for compressing the sheet stack. The pressing device is embodied in such a way that upon compression of the sheet stack it exerts a linear pressure either directly onto the sheet stack or from outside onto the binder. The plate is embodied as a pressing plate that is movable between an initial position and a pressing position offset toward the input opening.

### FIELD OF THE INVENTION

The present invention concerns a method for binding a sheet stack into a binder that comprises a binder spine having an adhesive strip present on its inner side, the sheet stack being inserted into the binder in such a way that the stack's end face comes into contact with the adhesive strip, after which the combination of sheet stack and binder having the binder spine is brought into contact against a plate and then the sheet stack is compressed by means of a pressing device, fanning out the end face of the sheet stack, and in that state an adhesive bond is created between the binder spine and sheet stack. The invention further refers to a binding apparatus for binding a sheet stack into a binder having a binder spine and having an adhesive strip present on the spine's inner side, the binding apparatus comprising an input slot that is delimited by a plate and has an input opening, as well as a pressing device for compressing the sheet stack.

### BACKGROUND OF THE INVENTION

It has been known for some time to produce company brochures, financial reports, marketing documents, or the like by binding the sheet stack that reproduces the contents into a binder that comprises a binder spine and binder covers continuous therewith. For that purpose, the binder spine has on the inner side an adhesive strip made of hot-melt adhesive. For binding, the combination of sheet stack and binder is put into a binding apparatus embodied as an office machine, and the binder spine is heated sufficiently that the hot-melt adhesive strip becomes plasticized and the ends of the sheet stack in contact therewith sink into the hot-melt adhesive strip. After removal of the combination, the hot-melt adhesive strip cools and thereby forms a permanent bond between the sheet stack and the binder.

Binders of this kind are known, for example, from U.S. Pat. No. 3,437,506, DE Patent 25 28 225, U.S. Pat. No. 4,244,069, U.S. Pat. No. 4,289,330, and EP 0 410 197 B1. Binding apparatuses suitable for binding are evident from DE Examined Application 22 56 259, U.S. RE 28,758, U.S. Pat. No. 3,973,778, U.S. Pat. No. 4,129,471, U.S. Pat. No. 4,141,100, DE 38 05 996 C2, and EP 0 581 394 B1. All the binding apparatuses are configured so that the combination of sheet stack and binder is inserted into an input slot that is open at the top, in such a way that the outer side of the binder spine faces downward. The binder spine is placed on a heating plate that closes off the input slot at the bottom, and is heated by that plate. To ensure that the combination maintains its vertical position, the binding apparatus comprises a pressing device that compresses the combination and holds it in the upright position. The pressing device is, as a rule, embodied so that at least one of the side walls delimiting the input slot is guided displaceably relative to the others, so that the width of the input slot can be modified and the combination can be held pressed between the two side walls.

In one method of the species (U.S. Pat. No. 4,141,100), a binder is used that comprises on the inner sides of the binder covers, in the vicinity of the binder spine, strips that are triangular in section, extend parallel to the binder spine, and are located opposite one another. Upon compression of the sheet stack by displacement of one of the two side walls of the input slot toward the other side wall, the sheet stack is intended thereby to be compressed in the region of the strips in order to hold the sheets of the sheet stack in their aligned position, and their lower edges in contact with the adhesive strip. Since compaction of the combination occurs above the strips, however, considerable doubt exists that the sheet stack is compressed—and the end face resting against the adhesive strip thus fanned out—in the manner depicted in FIG. 7 of U.S. Pat. No. 4,141,100. It may instead be assumed that the binder covers bulge outward in the region of the strips, and that the desired purpose is thus achieved not at all or in any event incompletely.

In the method according to U.S. Pat. No. 3,973,787, binders are used in which the binder spine and also the adhesive strip are wider than the end face, resting thereagainst, of the sheet stack provided for the purpose. For binding, the combination of sheet stack and binder is inserted into the input slot of a binding apparatus in which the two side walls are movable toward one another for the purpose of contact against the outer sides of the binder covers. Arranged at each of the lower ends of the side walls near the heating plate is a respective roller that is resiliently suspended on the side walls. Upon compaction of the combination, these rollers first come into contact against the outer sides of the binder covers, thus ensuring that the externally located sides of the sheet stack achieve good contact with the adhesive strip. The binder cover is, in this context, pushed against the outer sides of the sheet stack. Only after that do the side walls of the input slot come to rest against the outer sides of the binder covers.

The known binding methods that are carried out using the binders and binding apparatuses recited in the documents have the disadvantage that the adhesive bond is not as strong as is necessary, at least when greater stresses need to be applied. Since these methods are used to produce brochures that are often representative in nature, it is essential that-the brochures not fall apart even after repeated use.

To solve this problem it is proposed according to the earlier German patent application 103 21 419.4 or corresponding U.S. patent application Ser. No. 10/842,629, not previously published, that in the context of the pressing operation, the pressing device exert a linear pressure either directly onto the sheet stack or from outside onto the binder, and that a fanning-out of the end face of the sheet stack opposite the binder spine be thereby achieved. In contrast to the method of the species (U.S. Pat. No. 4,141,100), therefore, a fanning-out of the sheet stack is achieved here by means of a linear pressure exerted by the pressing device either directly onto the sheet stack or onto the combination of sheet stack and binder. By exertion of an appropriately strong linear pressure, fanning-out can be effected in such a way that an adhesive strip plasticized by heat penetrates into the interstices between the individual sheets, and a hitherto unattainable strength is thereby achieved, after cooling, in the bond between the binder spine and sheet stack. The fanning-out can be configured, by appropriate adjustment of the linear pressure, in such a way that the width of the end face of the sheet stack becomes greater than the thickness of the sheet stack in the uncompacted region, i.e. in the region that, viewed from the binder spine, is located remotely from the exertion of linear pressure.

The method concretely described in German patent application 103 21 419.4, and the binding apparatus proposed with respect to that method, are still capable of improvement in terms of maximally simple embodiment of the binding operation and, above all, of the binding apparatus.

### SUMMARY OF THE INVENTION

It is therefore the object of the present invention to embody a method for binding a sheet stack into a binder in such a way that the binding operation can be carried out quickly and efficiently. A further object is to make available a binding apparatus that has a simple construction.

The first part of the object is achieved, according to the present invention, in that upon exertion of the linear pressure, the binder spine is pushed, by movement of the plate against which the binder spine is resting, toward the end face of the sheet stack and against that end face. The basic idea of the invention is consequently to exert a pressure toward the end face of the sheet stack by means of the plate against which the binder spine is resting, in order to press the adhesive strip against the sheet stack and thereby also bring it between the sheets of the sheet stack. This procedure has considerable advantages over the procedure according to German patent application 103 21 419.4.

It is understood that, in the further developed method as well, it is advantageous if the sheet stack is fanned out by the compression in such a way that the width of the end face of the sheet stack becomes greater than the thickness of the sheet stack in the uncompacted region. A particularly good spreading effect is achieved if the sheet stack has linear pressure applied to it at a distance of 0.5 to 2 cm from its end face adjacent to the binder spine.

The linear pressure is advantageously applied using protruding pressing bars belonging to the pressing device. It is advantageous in terms of a maximally simple equipment embodiment that, upon exertion of the linear pressure, one of the pressing bars is held immovably and the other pressing bar is moved toward the one pressing bar.

The method according to the present invention is suitable in particular for binders in which an adhesive strip made of a pressure-sensitive contact adhesive or a hot-melt adhesive is used. In the latter case, heating of the hot-melt adhesive to the plasticizing temperature is usefully performed by heating the plate through the binder spine. The plate thus performs a dual function, of pressure exertion on the one hand and heating on the other hand. An adhesive strip whose width corresponds to at least 1.2 times the thickness of the sheet stack in the uncompacted state should preferably be used.

The second part of the object is achieved, according to the present invention, in that the pressing device is embodied—as in the case of German patent application 103 21 419.4—in such a way that upon compression of the sheet stack it exerts a linear pressure either directly onto the sheet stack or from outside onto the binder, but so that the plate that delimits the input slot is additionally embodied as a pressing plate that is movable between an initial position and a pressing position offset toward the input opening of the input slot. The binding apparatus according to the present invention thus has a simple construction whose operation is immediately apparent to persons who are familiar with previously known binding machines.

The movement of the pressing plate is usefully accomplished perpendicularly to its pressing surface, i.e. it should be mounted displaceably in that direction. As regards the alignment of the input slot, it is not absolutely necessary that it be open toward the top, i.e. extend vertically (as in the existing art). It can also be open obliquely upward or even toward the side, so that the combination of sheet stack and binder is inserted obliquely or even horizontally into the input slot.

For the movement of the pressing plate between the initial position and the pressing position, it is useful to provide a drive motor, for example an electric motor, since it simplifies operation.

To make the binding apparatus according to the present invention also suitable for binding with binders that have a hot-melt adhesive strip on the inner side of the binder spine, it is advantageous if the pressing plate is equipped with a heating device for plasticizing the adhesive strip. The pressing plate thus has a dual function. The heating device can be switched off for the compaction of binders having a pressure-sensitive adhesive strip.

According to a further feature of the invention, provision is made for the pressing device to comprise two pressing bars, movable relative to and toward one another, which are mounted on holding elements in such a way that they occupy a position protruding beyond the holding elements even during compaction of the sheet stack. The pressing bars can be rigidly mounted on the holding elements. The pressing bars should preferably extend at a distance of 0.5 to 2.0 cm from the pressing plate in the initial position, since a favorable fanning effect is thereby obtained.

The possibility exists of guiding both pressing bars movably in such a way that they are displaceable with respect to one another for pressing the sheet stack. A simpler solution, however, consists in mounting the one pressing bar in a manner fixed to the unit and the other pressing bar displaceably toward and away from the one pressing bar. The movable pressing bar should be driven by a drive motor, for example an electric motor.

It is clear that the binding apparatus comprises a control device, whereby the drive motor for the pressing plate and the drive motor for the pressing bar(s) is controllable so that after inserting the combination of binder and sheet stack, the pressing bar(s) is moved together first, and then the pressing plate is moved into the pressing position. By this, it is secured that the combination of binder and sheet stack is first of all fixed after the insertion into the input slot, before the pressing plate is moved into the pressing position.

### BRIEF DESCRIPTION OF THE DRAWINGS

The invention is illustrated in more detail, with reference to an exemplary embodiment, in the drawings, in which:

FIG. 1 is a perspective view of the binding apparatus according to the present invention; and

FIG. 2 is a vertical cross section through the binding apparatus according to FIG. 1.

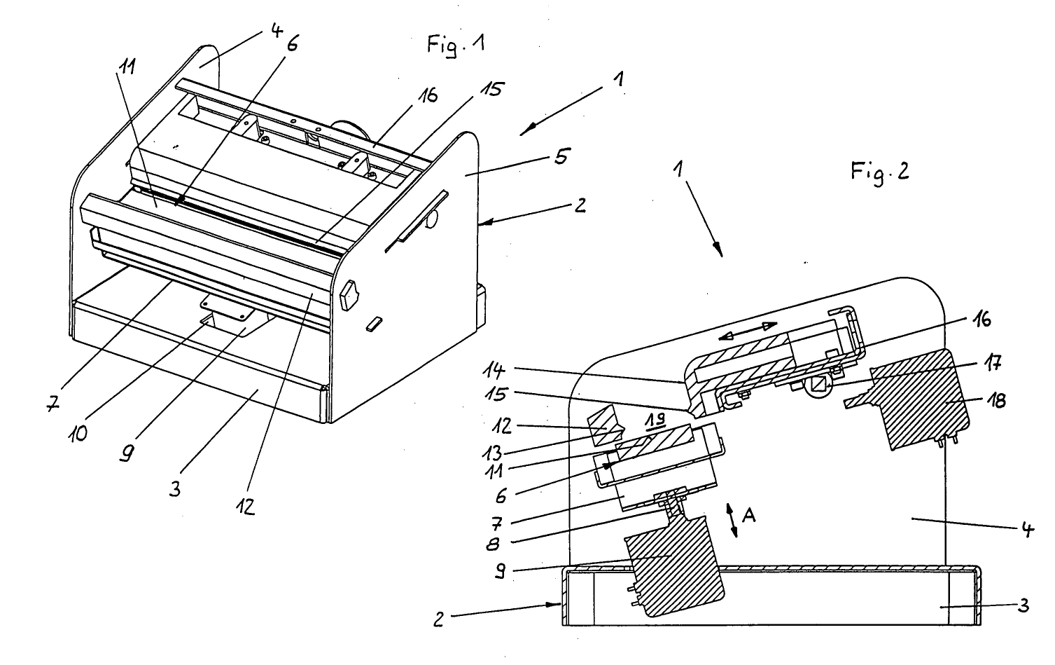

### DETAILED DESCRIPTION OF THE PREFERRED EMBODIMENT(S)

Binding apparatus 1 depicted in the Figures comprises a housing 2, which is constituted by a lower console 3 that is rectangular in outline and two side panels 4, 5 that project upward vertically from the two short end faces of console 3 and therefore run parallel to one another. Side panels 4, 5 are rigidly joined to console 3, for example by thread-joining or welding.

Extending between the two side panels 4, 5 is a pressing plate 6 that is held in a mount 7 that is guided laterally. Mount 7 sits on the exposed end of a spindle drive 8 that is connected to an electric motor 9. Electric motor 9 sits in a recess 10 of console 3 and is fixedly held therein. By way of spindle drive 8, pressing plate 6 can be moved in accordance with double arrow A back and forth, i.e. perpendicularly to its pressing surface 11, between an initial position (shown here) and an elevated pressing position. The surface is inclined somewhat with respect to the vertical.

Arranged above pressing plate 6 is a bar 12 that extends parallel to pressing plate 6 and is retained fixedly between the two side panels 4, 5. Bar 12 constitutes a pressing bar 13, triangular in cross section, that extends along bar 12 above and parallel to pressing plate 6. Provided opposite bar 12 is a pressing carriage 14 whose end face located opposite bar 12 likewise constitutes a pressing bar 15. The two pressing bars 13, 15 extend over the entire length of pressing plate 6 and lie in a plane that extends parallel to pressing surface 11 of pressing plate 6. Pressing carriage 14 is also guided movably in this plane, in accordance with double arrow B.

Pressing carriage 14 sits on a pressing carriage base 16 that is clamped fixedly between side panels 4, 5 and is bent upward at its rear end. Pressing carriage 14 has on the lower side, in the region of a cutout of pressing carriage base 16, a toothed rack (not visible) which meshes with a gear 17 that is mounted, below pressing carriage base 16, rotatably about an axis extending parallel to pressing bars 13, 15. Gear 17 is connected via a linkage (not depicted here) to a drive motor 18 which is arranged between side panels 4, 5 and on which a corresponding support (not shown here in further detail) is held.

Pressing plate 6, bar 12, and pressing carriage 14 constitute an input slot 19 into which a binder having an inserted sheet stack can be introduced obliquely from above. This is done, as in the case of the binding machines known in the existing art, in such a way that the combination of binder and sheet stack is inserted into input slot 19 with the binder spine toward the bottom, so that the binder spine comes into planar contact against pressing surface 11. After insertion, the binding operation is initiated by firstly setting drive motor 18 in motion. This can be effected, for example, automatically by way of a photoelectric barrier that is breached upon insertion of the combination of binder and sheet stack, or by actuation of an actuation button. Drive motor 18 is caused to move rotationally in such a way that pressing carriage 14 is moved toward bar 12. The consequence of this is that the combination of sheet stack and binder is clamped between pressing bars 13, 15 approximately 8 mm above pressing surface 11, with sufficient force that the sheet stack is fanned out at the end face located opposite the adhesive strip, so that the sheet stack has a greater width at that end face than above pressing bars 13, 15, i.e. where it is not being compacted.

After the combination of binder and sheet stack is clamped between pressing bars 13, 15, electric motor 9 is activated in such a way that pressing plate 6 is elevated toward pressing bars 13, 15. The binder spine having the adhesive strip is thereby pressed firmly against the oppositely located end face of the sheet stack, the lower sides of bar 12 and of pressing carriage 14 serving as stops for pressing plate 6.

Pressing plate 6 is equipped with a heating device in the form of an electrical resistance heater, so that not only binders having a pressure-sensitive contact adhesive strip on the inner side of the binder spine, but also binders whose binder spine is equipped on the inner side with a hot-melt adhesive strip, can be used for the binding operation. The heating device can be controlled in a manner known per se, i.e. the heating device is also switched on when binding apparatus 1 is switched on. Once the binder spine has been sufficiently heated and has been pressed against the sheet stack, pressing carriage 14 is moved back into its initial position as shown, so that the combination of binder and sheet stack can be removed and placed upright on a cooling stand. At the same time, the heating device in pressing plate 6 is either switched off or switched into a standby mode, if multiple binding operations are to be performed successively.

It is understood that input slot 19 can also be extended upward, for example by way of a support plate leading upward from bar 12 perpendicularly to pressing surface 11. In this fashion it is not necessary for the combination of binder and sheet stack to be held manually until it is clamped. Such an extension of input slot 19 furthermore prevents that combination from falling out of binding apparatus 1 after pressing carriage 14 is moved back into its initial position.

1. A method for binding a sheet stack into a binder that comprises a binder spine having an adhesive strip present on its inner side, the sheet stack being inserted into the binder in such a way that the stack's end face comes into contact with the adhesive strip, after which the combination of sheet stack and binder having the binder spine is brought into contact against a plate (6) and then the sheet stack is compressed by means of a pressing device, fanning out the end face of the sheet stack, and in that state an adhesive bond is created between the binder spine and sheet stack,
wherein upon compression of the sheet stack, the pressing device exerts a linear pressure either directly onto the sheet stack or from outside onto the binder; and in that context the binder spine is pressed, by movement of the plate (6) toward the end face of the sheet stack, against that end face.

2. The method according to claim 1, wherein the sheet stack is fanned out by the compression in such a way that the width of the end face of the sheet stack becomes greater than the thickness of the sheet stack in the uncompacted region.

3. The method according to claim 1, wherein the sheet stack has linear pressure applied to it at a distance of 0.5 to 2 cm from its end face adjacent to the binder spine.

4. The method according to claim 1, wherein the sheet stack has linear pressure applied to it by way of protruding pressing bars (13, 15) belonging to the pressing device.

5. The method according to claim 4, wherein upon exertion of the linear pressure, one of the pressing bars (13) is held immovably and the other pressing bar (15) is moved toward the one pressing bar (13).

6. The method according to claim 1, wherein a binder spine having an adhesive strip made of hot-melt adhesive is used, and that adhesive strip is heated to a plasticizing temperature when the sheet stack is compressed.

7. The method according to claim 6, wherein plasticization of the hot-melt adhesive is performed by heating the plate (6) through the binder spine.

8. The method according to claim 1, wherein an adhesive strip whose width corresponds to at least 1.2 times the thickness of the sheet stack in the uncompacted state is used.

9. A binding apparatus (1) for binding a sheet stack into a binder having a binder spine and having an adhesive strip present on the spine's inner side, the binding apparatus (1) comprising an input slot (19) that is delimited by a plate (6) and has an input opening, as well as a pressing device for compressing the sheet stack,
wherein the pressing device is embodied in such a way that upon compression of the sheet stack it exerts a linear pressure either directly onto the sheet stack or from outside onto the binder; and the plate is embodied as a pressing plate (6) that is movable between an initial position and a pressing position offset toward the input opening.

10. The binding apparatus according to claim 9, wherein the pressing plate (6) is mounted displaceably perpendicularly to its pressing surface (11).

11. The binding apparatus according to claim 9, wherein the input slot is open toward the side, obliquely upward, or toward the top.

12. The binding apparatus according to claim 9, wherein the pressing plate (6) is movable, via a drive motor (9), back and forth between the initial position and the pressing position.

13. The binding apparatus according to claim 9, wherein the pressing plate (6) is equipped with a heating device for plasticizing the adhesive strip.

14. The binding apparatus according to claim 9, wherein the pressing device comprises two pressing bars (13, 15), movable relative to and toward one another, which are mounted on holding elements (12, 14) in such a way that they occupy a position protruding beyond the holding elements (12, 14) even during compaction of the sheet stack.

15. The binding apparatus according to claim 14, wherein the pressing bars (13, 15) are rigidly mounted on or shaped onto the holding elements (12, 14).

16. The binding apparatus according to claim 14, wherein the pressing bars (13, 15) extend at a distance of 0.5 to 2.0 cm from the pressing plate (6) in the initial position.

17. The binding apparatus according to claim 14, wherein the one pressing bar (13) is mounted in a manner fixed to the unit and the other pressing bar (15) displaceably toward and away from the one pressing bar (13).

18. The binding apparatus according to claim 18, wherein the movable pressing bar (15) is driven by a drive motor (18).

19. The binding apparatus according to claim 12, wherein the binding apparatus comprises a control device, whereby the drive motor (9) for the pressing plate (6) and the drive motor (18) for the pressing bar (15) or the pressing bars (13, 15) are controllable so that first the pressing bars (13, 15) are moved together and then the pressing plate (6) is moved into the pressing position.
